(19) United States
(12) Patent Application Publication
(10) Pub. No.: US 2003/0229998 A1
(43) Pub. Date: Dec. 18, 2003

(54) Apparatus for producing wall panels

(76) Inventor: Dieter Ainedter, Salzburg (AT)

Correspondence Address: FLYNN, THIEL, BOUTELL & TANIS, P.C., 2026 Rambling Road, Kalamazoo, MI, 49008-1699, US

(21) Appl. No.: 10/173,128

(22) Filed: Jun. 17, 2002

(51) Int. Cl. E04D 15/00; E04F 21/00; E04G 21/14; B43L 13/00; G01C 15/10

(52) U.S. Cl. 33/410; 52/749.14

(57) ABSTRACT

For producing wall panels (8) from bricks (1), a line-up path (4) on which bricks to be masoned are deposited in a row with a gripper, a transfer device (10) for transporting the brick row from the line-up path (4) to a bricklaying station (7) for masoning the wall panel, and a device for moving apart the bricks to form vertical joints (9) between the bricks (1) of the wall panel (8) are provided. The gripper depositing the bricks (1) on the line-up path (4) is formed by a depiling gripper (3) that depiles the bricks (1) of a pile (2) in rows with its two longitudinal grippers (13, 14). The device for moving apart the bricks (1) is formed by transverse grippers (21, 21a) disposed on the depiling gripper (3) between the longitudinal grippers (13, 14), said transverse grippers (21, 21a) individually holding the bricks (1) of the brick row depiled with the longitudinal grippers (13, 14) and being formed to be movable in the longitudinal direction of the depiling gripper (3).

This invention relates to an apparatus for producing wall panels according to the generic part of claim 1.

Such an apparatus is known from DE 198 30 985 A1. Bricks to be masoned are placed by a gripper on a line-up path formed as an endless conveyor that conveys them in groups in a row against a stop. The actual length of the groups of bricks thus pushed together in abutting relationship is determined with a light barrier disposed on the endless conveyor. The device for moving apart the bricks is formed by the transfer device for transporting the particular group of bricks from the line-up path to the brick-laying station for them to be masoned into the wall panel on a mortar bed on the lower brick row there. The transfer device is formed as a row gripper whose individual grippers are guided movably via individually driven pinions along a rack.

The bricks to be masoned have different lengths due to production-related tolerances. The tolerance deviations of the bricks can be compensated with such an apparatus by vertical joints of varying width. Further, a raw brick wall, a so-called fair-faced wall, can be produced with an optically appealing joint width. However, the productive capacity of the known apparatus leaves something to be desired.

This is because bricks are first removed from a pallet stack here, then deposited on a conveying device and conveyed in groups against a stop. After measurement of the length of a group of e.g. three bricks, the latter are then gripped again, pulled apart to size and deposited at their position in the wall (by a gripper traveling in the direction of the wall).

The problem of the invention is therefore to clearly increase the productive capacity of such an apparatus.

This is obtained according to the invention by the apparatus characterized in claim 1. Subclaims 2 to 7 render advantageous embodiments of the invention. Claim 8 is directed to the preferred use of the inventive apparatus for producing wall panels for fair-faced walls.

According to the invention, the pile gripper has longitudinal grippers for gripping a brick row of a brick pile and pushing it together into a block in the longitudinal direction, and transverse grippers for individually gripping each single brick of a brick row. The transverse grippers are adapted to travel in the longitudinal direction of the pile gripper for moving apart the bricks of a depiled, gripped brick row.

The brick row can accordingly first be gripped from the brick pile by the longitudinal grippers while the transverse grippers are moved apart and open. Regripping is done in the air. The transverse grippers grab while the longitudinal grippers are being moved apart. In this gripping position the transverse grippers can then be moved apart in the longitudinal direction of the pile gripper for accordingly aligning the bricks.

The depiling gripper preferably has a measuring device integrated therein for measuring the actual length of the depiled brick rows, and a positioning apparatus for moving apart the bricks of the brick row gripped by the transverse grippers to the nominal length.

The measuring device expediently detects the distance between the longitudinal grippers that corresponds to the length of the gripped brick row while the latter is gripped by the depiling gripper.

A pile gripper is preferably adapted to travel from the delivery station where the brick piles are deposited to the line-up path.

The line-up path is preferably formed by a conveyor, which can be formed for example as a transport belt or similar endless conveyor or roller conveyor.

Alternatively, for processing suitable bricks made e.g. of chalky sandstone instead of brick material, the transverse grippers can be equipped with vacuum suction means and formed only on one side.

In the following the invention will be explained in more detail by way of example with reference to the enclosed drawing, in which:

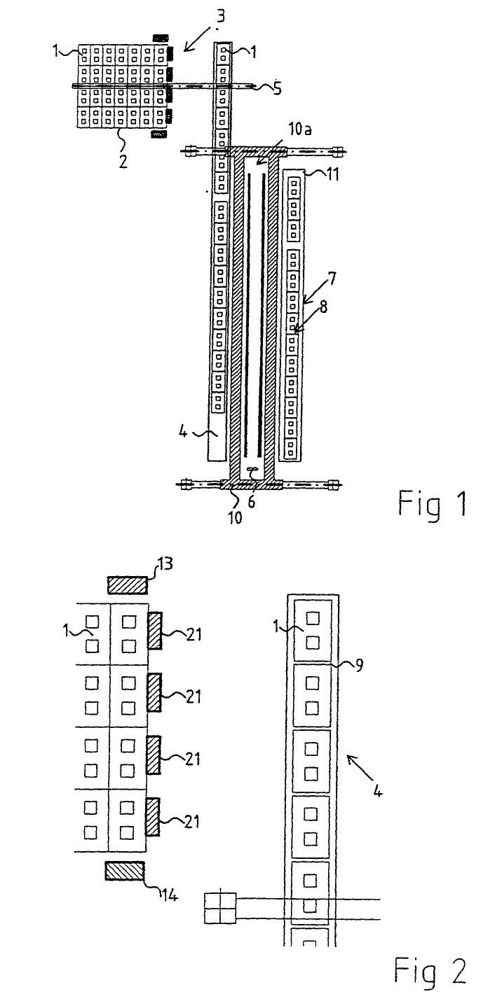

FIG. 1 shows schematically the plan view of an apparatus for producing wall panels from bricks;

FIG. 2 shows an enlarged representation of the plan view according to FIG. 1 in the area of the brick pile and the line-up path;

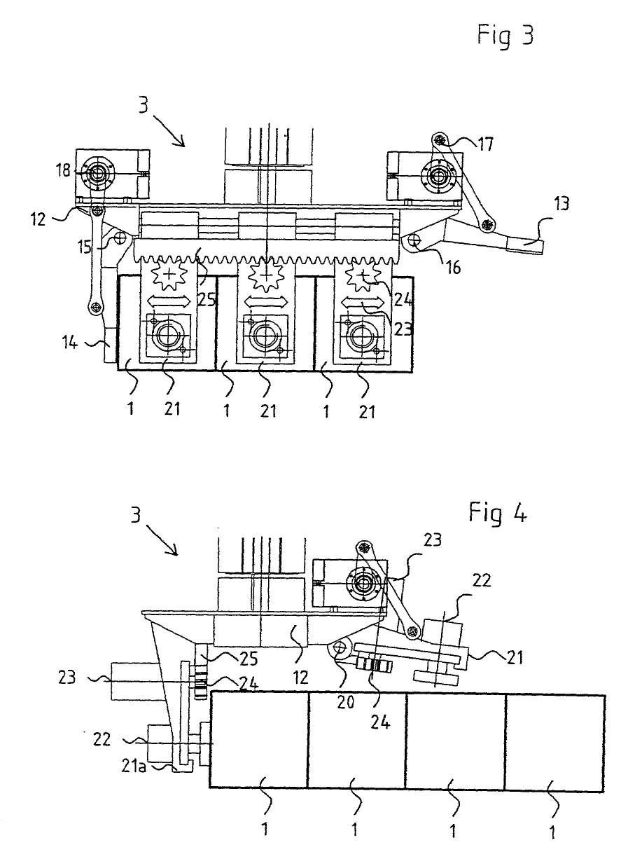

FIG. 3 shows a side view of the depiling gripper; and

FIG. 4 shows a side view of the depiling gripper rotated by 90 degrees.

According to FIG. 1, bricks 1 to be processed are delivered in the form of palletized brick piles 2. Bricks 1 of pile 2 are deposited with depiling gripper 3 on line-up path 4. Depiling gripper 3 is adapted to travel along guide 5 extending across one end of line-up path 4.

Line-up path 4 is formed as a conveyer belt, roller conveyor or similar conveyor for lining up bricks 1 to be masoned deposited by depiling gripper 3 along line-up path 4 in a predetermined number, at the distance apart as deposited by depiling gripper 3.

Bricks 1 lined up on line-up path 4 are transported with transfer device 10 with gripper 10a shown schematically in the direction of arrow 6 to brick-laying station 7 disposed parallel to line-up path 4, where wall panel 8 is masoned.

The first brick row on line-up path 4 is deposited for this purpose on base 11 provided at brick-laying station 7. A mortar bed is applied and then the second wall row from line-up path 4 placed on with transfer device 6, and so on, until wall panel 8 has been masoned to the predetermined height.

For masoning a fair-faced wall, vertical joints 9 between bricks 1 of wall panel 8 are to have a certain width so as to be mortared perfectly.

According to the invention, bricks 1 are for this purpose depiled from brick pile 2 in rows with depiling gripper 3, then moved apart to the desired joint width with depiling gripper 3 and deposited on the conveyor of line-up path 4 so that a joint of equal width also forms between the last brick of the next to last deposited depiled brick row and the first brick of the last deposited brick row. The last deposited brick row is thus moved on with the conveyor by the measure of its length plus one joint width.

According to FIG. 3, pile gripper 3 has a pair of grippers 13, 14 that grips a brick row of brick pile 1. Each brick row can consist of three bricks 1 as shown in FIG. 2, or of e.g. four according to FIG. 1. Longitudinal grippers 13, 14 are hinged to carrier 12 of depiling gripper 3 to swivel about axle 15, 16 above bricks 1 and are actuated by crank mechanism 17, 18. Longitudinal grippers 13, 14 are thus used to remove a whole brick row from brick pile 2, thereby pressing bricks 1 of a row against each other.

Between longitudinal grippers 13, 14, pairs of transverse grippers 21, 21a are provided, as shown in FIG. 4. The number of transverse gripper pairs 21, 21a is selected to be as great as the maximum number of bricks per row of brick pile 2. Transverse gripper pairs 21, 21a grip at right angles to the gripping direction of longitudinal grippers 13, 14. Transverse grippers 21 are likewise hinged to carrier 12 above bricks 1 to swivel about axle 20 and can be swiveled away upward so as not to collide with the brick rows on the pile not yet depiled when a brick row is gripped.

Bricks 1 of a whole brick row of brick pile 2 are picked up and gripped with longitudinal grippers 13, 14 and then regripped preferably in the air with transverse gripper pairs 21, 21a. Either all or only single bricks 1 of a row of brick pile 2 can be thereby deposited on line-up path 4.

Transverse gripper pairs 21, 21a are adapted to travel in the longitudinal direction, i.e. the gripping direction of longitudinal grippers 13, 14, in synchronism in pairs, so that the bricks gripped by transverse grippers 21, 21a can be pulled apart as soon as longitudinal grippers 13, 14 have been swiveled apart.

The traveling ability of transverse gripper pairs 21, 21a is shown by arrows 23. Transverse grippers 21, 21a are each driven individually by pinion 24 engaging rack 25 extending in the longitudinal direction of depiling gripper 3 and fastened to carrier 12.

The position of a gripped brick row can be displaced toward the center axis of depiling gripper 3. The actual position can be determined from measurement of the pivoting angle of longitudinal grippers 13, 14 about axles 15, 16. For depositing the gripped bricks, the target coordinates for depiling gripper 3 are corrected in accordance with the measured dimension. Transverse grippers 21, 21a are used to move apart bricks 1 of the brick row gripped by depiling gripper 3 to form joints 9 between bricks 1 of wall panels 8. A positioning device is provided for this purpose that moves apart the bricks of the brick row gripped by transverse grippers 21, 21a to the nominal length or width of the joint that the relevant brick row assumes in wall panel 8.

In the alternative application of the depiling gripper for walls with unmortared joints, the brick rows that are depiled from the pile are first pushed together with the longitudinal grippers, measured and then pulled apart again to a predetermined measure with the transverse grippers. Dimensional imperfections of the processed bricks due to brick tolerances are thus taken up in the vertical joints.

1. An apparatus for producing wall panels from bricks, having a line-up path on which bricks to be masoned are deposited in a row with a gripper, and a device for moving apart the bricks to form vertical joints between the bricks of the wall panel, characterized in that the gripper depositing the bricks (1) on the line-up path (4) is formed by a depiling gripper (3) that depiles the bricks (1) of a pile (2) in rows with its two longitudinal grippers (13, 14), and the gripper has a device for moving apart the bricks (1) that is formed by transverse grippers (21, 21a) disposed on the depiling gripper (3) between the longitudinal grippers (13, 14) and individually holding the bricks (1) of the brick row depiled with the longitudinal grippers (13, 14).

2. An apparatus according to claim 1, characterized by a control device that moves apart the longitudinal grippers (13, 14) for moving apart the brick row with the transverse grippers (21, 21a).

3. An apparatus according to claim 1 or 2, characterized in that for measuring the actual length of the depiled brick row a measuring device is provided that detects the distance between the longitudinal grippers (13, 14) and transfers the value to a control device.

4. An apparatus according to any of the above claims, characterized by a positioning device that moves apart the bricks of the brick row gripped by the transverse grippers (21, 21a) to the nominal length of the brick row.

5. An apparatus according to any of the above claims, characterized in that the line-up path (4) is formed by a conveyor.

6. An apparatus according to any of the above claims, characterized in that the distance between the transverse grippers is adjustable to adapt to different brick widths by either the mountings of the gripper jaws being adapted to travel toward each other, or the stroke of the cylinders being accordingly great.

7. An apparatus according to any of the above claims, characterized in that the longitudinal grippers (13, 14) are hinged to swivel on the carrier (12) of the depiling gripper (3).

8. An apparatus according to any of the above claims, characterized in that the transverse grippers (21, 21a) are formed by gripper pairs attacking the bricks (1) on both sides.

9. An apparatus according to any of claims 1 to 7, characterized in that the transverse grippers are formed by vacuum grippers attacking the bricks (1) on one side.

10. An apparatus according to any of the above claims, characterized in that the control device is formed so that the regripping of the bricks (1) from the longitudinal grippers (13, 14) to the transverse grippers (21, 21a) and the pulling apart of the bricks (1) with the transverse grippers (21, 21a) are effected in the air during motion of the gripper from the pile (2) to the line-up path (4).

11. An apparatus according to any of the above claims, characterized in that the depiling gripper (3) has the same number of transverse grippers (21, 21a) as the number of bricks (1) of a pile row when processing the shortest bricks.

12. An apparatus according to claim 1, characterized in that a transfer device is provided for transporting the brick row from the line-up path to a brick-laying station for masoning the wall panel.

13. An apparatus according to claim 1, characterized in that the transverse grippers (21, 21a) are formed to be movable in the longitudinal direction of the depiling gripper (3).

14. Use of the apparatus according to any of the above claims for producing wall panels for fair-faced brickwork.

15. Use of the apparatus according to any of claims 1 to 13 for additional fine adjustment due to measuring errors of the bricks (1).
